(19) United States
(12) Patent Application Publication
(10) Pub. No.: US 2008/0084869 A1
(43) Pub. Date: Apr. 10, 2008

(54) Using Registration State to Determine Potential Change in User Location

(75) Inventors: John Hearty, Golden, CO (US); Mudassir Fajandar, Broomfield, CO (US); Ronald Matthew Munoz, Arvada, CO (US); Daniel Ryan, Louisville, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: LEVEL 3 COMMUNICATIONS, INC., Broomfield, CO (US)

(21) Appl. No.: 11/535,882

(22) Filed: Sep. 27, 2006

(51) Int. Cl. H04L 12/66

(52) U.S. Cl. 370/352

(57) ABSTRACT

A method for determining potential relocation of an IP-enabled telephony device involves subscribing to a registration events package of a VoIP network, receiving one or more notifications indicating a registration state of the IP-enabled telephony device, and determining that the IP-enabled telephony device has potentially relocated, based on the registration state changes. A system for determining potential relocation of a user of a VoIP-enabled device includes an application server that includes a user relocation determination application that subscribes to a VoIP registration events package and determines whether the user has potentially relocated based on a change in registration state of the user's VoIP-enabled device.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006 Level 3 Communications, Inc.

### TECHNICAL FIELD

Embodiments of the present invention generally relate to systems and methods that provide for determination of potential relocation of a user of an Internet protocol (IP)-enabled device, and more specifically for determination of potential relocation of a Voice over IP (VoIP)-enabled device based on Session Initiation Protocol (SIP) registration state.

### BACKGROUND

Internet protocol (IP)-based telephony is becoming more and more commonplace. Users often prefer IP-enabled telephonic devices because they offer many benefits over conventional telephone service, such as lower price and a wider variety of services. Users typically subscribe to an online service provider (OSP) (e.g., America Online), which provides equipment such as a terminal adapter, IP-enabled telephone, or softphone, which enable the user to access and telephonically communicate over the Internet. Once online, the OSP provides network services, keeps track of the user's bills, and may determine the user's location for E911 purposes, or other reasons. In a typical network architecture, the user's equipment initially accesses the network via an Internet service provider (ISP) network that is different or logically separate from the OSP network. The ISP provides the actual physical connection to the network. Because of this arrangement, in which the OSP and ISP are often different or separate entities, the OSP often cannot determine necessary information about the subscriber or his/her equipment.

For example, for billing purposes, it is important that the OSP know when the subscriber begins using the telephonic equipment (e.g., terminal adapter). However, the OSP often cannot determine whether or when the equipment is first connected to the network. This is because the subscriber typically does not connect directly to the OSP's network. Because the OSP has no easy way of determining when the equipment first begins using the network, the OSP has no way of knowing the start of the billing time period. Conventionally, OSPs have selected some arbitrary time period after delivery of the equipment to the user, at which to begin billing. In other words, the OSP assumes that the equipment comes online at some arbitrary time, which in fact may be very different from the date/time that the equipment actually does come online. As a result, subscriber bills may not be accurate. Obviously, subscribers may not be happy with such an arrangement.

In addition, OSPs must be able to determine the location of VoIP-enabled telephone users for various reasons. One reason for determining user location is for emergency situations, and in particular when the user dials “911” for emergency personnel. Enhanced 911 (E911) is a service that associates the caller's physical address with the callers telephone number, so that emergency personnel can rapidly respond to the location. Of course, in a VoIP environment, the IP-enabled telephones are often mobile, thereby adding to the complexity of determining a subscriber's location and, in addition, whether the subscriber has moved locations.

It is with respect to these and other considerations that the present invention has been made.

### SUMMARY

Generally, the present invention involves determining whether a user of a telephony device may have changed locations. Such a process may indicate the likelihood of whether a user has relocated, and could reduce the number of times that a user's location needs to be determined.

An embodiment of the present invention is practiced as a method for determining potential relocation of an IP-enabled telephony device. The method according to this embodiment involves subscribing to a registration events package of a VoIP network, receiving one or more notifications indicating a registration state of the IP-enabled telephony device, and determining that the IP-enabled telephony device has potentially relocated, based on changes in registration state. The method may further involve determining that a billing process should begin based on the IP-enabled telephony device's entry into the active registration state.

Another embodiment of the present invention is practiced as a system for determining potential relocation of a user of a VoIP-enabled device. The system according to this embodiment includes an application server that includes a user relocation determination application that subscribes to a VoIP registration events package and determines whether the user has potentially relocated based on a change in registration state of the user's VoIP-enabled device. The application server may be further operable to determine that the VoIP-enabled device has potentially relocated based on a change in registration state from a terminated registration state to an active registration state.

Yet another embodiment of the present invention relates to a computer-implemented process for determining the potential relocation of a user of a VoIP-enabled device. The process according to this embodiment involves subscribing to a registrar of a VoIP network associated with a customer VoIP-enabled device, receiving a message from the registrar indicating that the customer VoIP-enabled device has entered an active state for the first time, and, based on the message indicating that the VoIP-enabled device has entered the active state for the first time, beginning a billing process to bill the customer for use of the VoIP-enabled device. The process may further involve receiving one or more other messages from the registrar indicating that the VoIP-enabled device has re-entered the active state from a terminated state, and, based on the message indicating that the VoIP-enabled device has reentered the active state from the terminated state, determining that the VoIP-enabled device has potentially relocated.

The various embodiments of the present invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features, as well as advantages, which characterize the present invention, will be apparent from a reading of the following detailed description and a review of the associated drawings.

### BRIEF DESCRIPTION OF THE DRAWINGS

FIG. 1 schematic diagram illustrating an exemplary Voice over Internet Protocol (VoIP) operating environment in accordance with one embodiment.

FIG. 2 is a functional block diagram illustrating a system that can be employed in the operating environment of FIG. 1 to provide for registration event detection and state notification in accordance with one embodiment.

FIG. 3 is a communication diagram illustrating an exemplary Session Initiation Protocol (SIP) communication messaging scenario that might occur among the entities shown in FIG. 2.

FIG. 4 illustrates a finite state machine that can be implemented by a SIP registration server such as that shown in FIG. 3.

FIG. 5 is a flowchart illustrating an algorithm that can be carried out by an application server such that shown in FIG. 2 to determine whether a VoIP subscriber might have relocated.

FIG. 6 is a schematic diagram of a computing device upon which embodiments of the present invention may be implemented and carried out.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Prior to describing one or more preferred embodiments of the present invention, definitions of some terms used throughout the description are presented.

### Definitions

A “module” is a self-contained functional component. A module may be implemented in hardware, software, firmware, or any combination thereof.

The terms “connected” or “coupled” and related terms are used in an operational sense and are not necessarily limited to a direct connection or coupling.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification or Appendix states a component or feature “may”, “can”, “could”, or “might” be included or have a characteristic, that particular component or feature is not required to be included or have the characteristic.

The terms “responsive” and “in response to” includes completely or partially responsive.

The term “computer-readable media” is media that is accessible by a computer, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

### Exemplary System

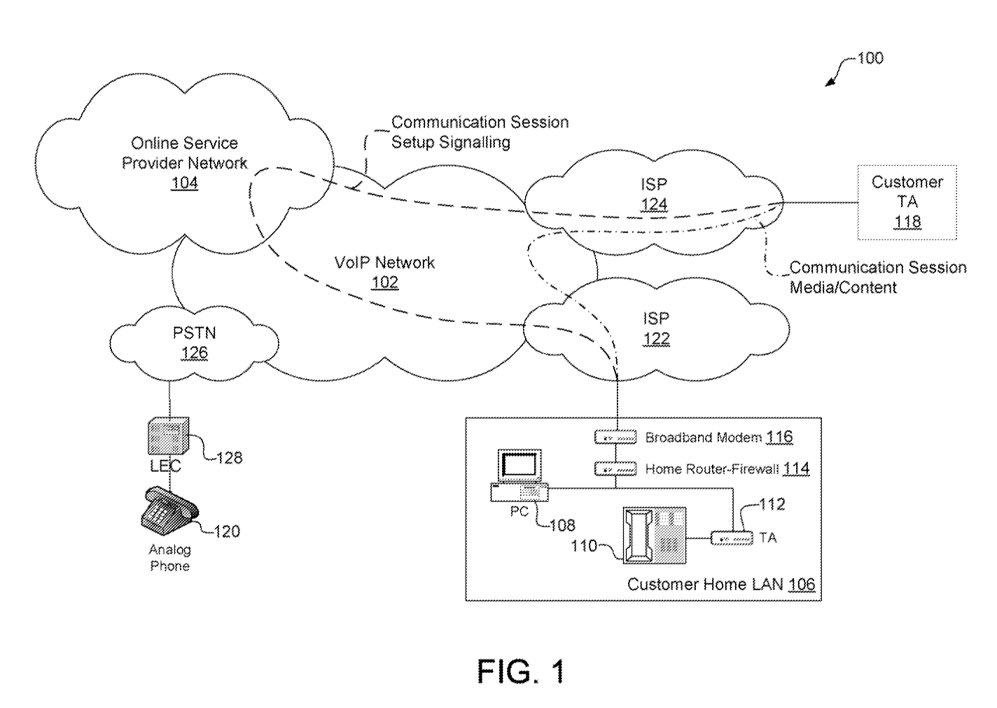

FIG. 1 illustrates an exemplary operating environment 100 employing a registrar and a registration events package for notifying a third party about a user's registration state. The environment 100 provides for setting up Voice over Internet Protocol (VoIP) communication sessions between network users using Session Initiation Protocol (SIP). Under SIP, telephonic devices register with the network in order to receive calls over the network. Registration identifies the network user and/or the user's telephonic device such that when the network attempts to setup a call to the telephonic device, the network knows where to send the call attempt. VoIP-enabled telephonic devices can be in one of a number of registration states. A third party can subscribe to a registration events package, to obtain the registration state of a VoIP resource, such as a VoIP device, and determine if the device and its user might have relocated.

With specific reference to FIG. 1, the environment 100 includes a VoIP network 102 provided by a wholesale network service provider. The VoIP network 102 includes numerous components such as, but not limited to gateways routers, and registrars, which enable communication across the VoIP network 102, but are not shown or described in detail here because those skilled in the art will readily understand these components. More relevant to this description is the interaction and communication between the VoIP network 102 and other entities, such as an Online Service Provider (OSP) network 104 and one or more customer home or business local area networks (LANs) 106.

Customer network 106 can include communication devices such as, but not limited to, a personal computer (PC) 108 or a telephone 110 connected to a telephone adapter (TA) 112. The PC 108 may include softphone software that makes the PC 108 VoIP-enabled (e.g., able to communicate via the VoIP network 102). Customer network 106 may also include a home router/firewall 114 and a broadband modem 116. The communication and networking components of the customer network 106 enable a user at the customer network 106 to communicate via the VoIP network 102 to other communication devices, such as another customer TA 118 and/or an analog telephone 120. Components of the customer network 106 are typically home- or business-based, but they can be relocated and may be designed for easy portability. For example, the telephone 110 may be wireless (e.g., cellular), and may have a built-in terminal adapter, thereby obviating the separate TA 112. As another example, the PC 108 could be replaced with a VoIP-enabled handheld computing device.

The customer network 106 typically connects to the VoIP network 102 via an Internet Service Provider (ISP) network 122. Similarly, customer TA 118 accesses, and is accessed by, the VoIP network 102 via another ISP network 124. The ISP 122 and ISP 124 are typically provided and maintained by a business or organization such as a local telephone company or cable company. Such ISP companies can provide for dial-up modem access and/or broadband access such as cable or a digital subscriber line. The ISPs may provide network/communication-related services to their customers. The analog telephone 120 accesses, and is accessed by, the VoIP network 102 via a public switched telephone network (PSTN) 126 and a local exchange carrier (LEC) 128. Communication via any of the networks can be wired, wireless, or any combination thereof.

In one embodiment, the TA 112 is provided to the user of customer network 106 by the OSP associated with OSP network 104. The OSP provides services to the customer, such as, but not limited to, call setup services, call forwarding, email, access to various content such as newsgroups, and/or an Internet homepage. Examples of OSPs are America Online™ (AOL), Prodigy™, and Compuserve™. The OSP also attempts to keep track of the geographic location of the customer for various purposes, such as, but not limited to, Enhanced 911 (E911). The OSP bills the customer for use of the TA 112 and network services. As such, the OSP uses various information obtained from the VoIP network 102 to determine when the customer first begins using the TA 112 and/or when the customer may have relocated.

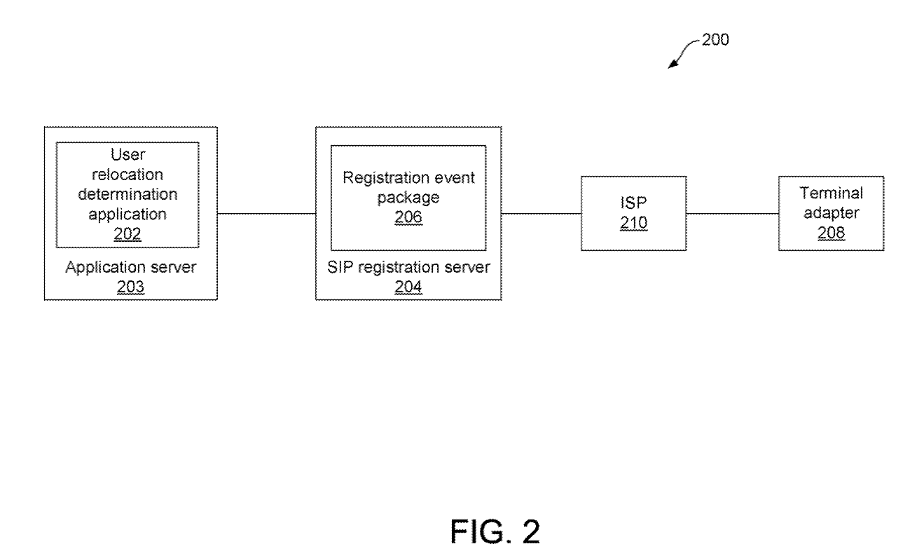

Referring again to the customer network 106, the TA 112 and PC 108 register with the VoIP network 102 in order to receive calls from others via the network 102. Registration identifies the telephonic device and/or the customer; once registered, the VoIP network 102 recognizes the device and/or the user when a communication session (e.g., a call) is to be set up. The VoIP network 102 includes a registrar (e.g., a registration server) hosting a registration events package that can monitor and detect registration events related to the customer. The OSP can choose to be notified about registration state by subscribing to the registration events package. FIG. 2 illustrates a system that may be implemented in the environment 100 for facilitating such an arrangement.

FIG. 2 illustrates a system 200 including functional modules that can be employed in the operating environment of FIG. 1 to provide for determining when a VoIP device is first connected to the network, as welt as determining potential user/device relocation based on registration state. More specifically, the modules in the system 200 enable a third party, such as an OSP, to determine when a VoIP device is first connected to the network, and if the user may have relocated, based on messages received from a VoIP network.

In the embodiment shown, the OSP includes a user relocation determination application 202. The relocation determination application 202 may execute on an application server computer 203. The relocation determination application 202 is in communication with a SIP registration server 204, which hosts a registration events package 206. The SIP registration server 204 and the registration events package 206 are employed by or within a VoIP network that facilitates communications to and from a terminal adapter (TA) 208. The Internet Engineering Task Force (IETF) Request for Comments (RFC) 3680 entitled “A Session Initiation Protocol (SIP) Event Package for Registrations” describes and specifies a registration events package that may be used in accordance with one embodiment. In general, the registration events package 206 detects registration related events associated with an identified resource, such as the TA 208. The TA 208 registers with the SIP registration server 204 via an ISP 210, so that the TA 208 is recognized on the VoIP network.

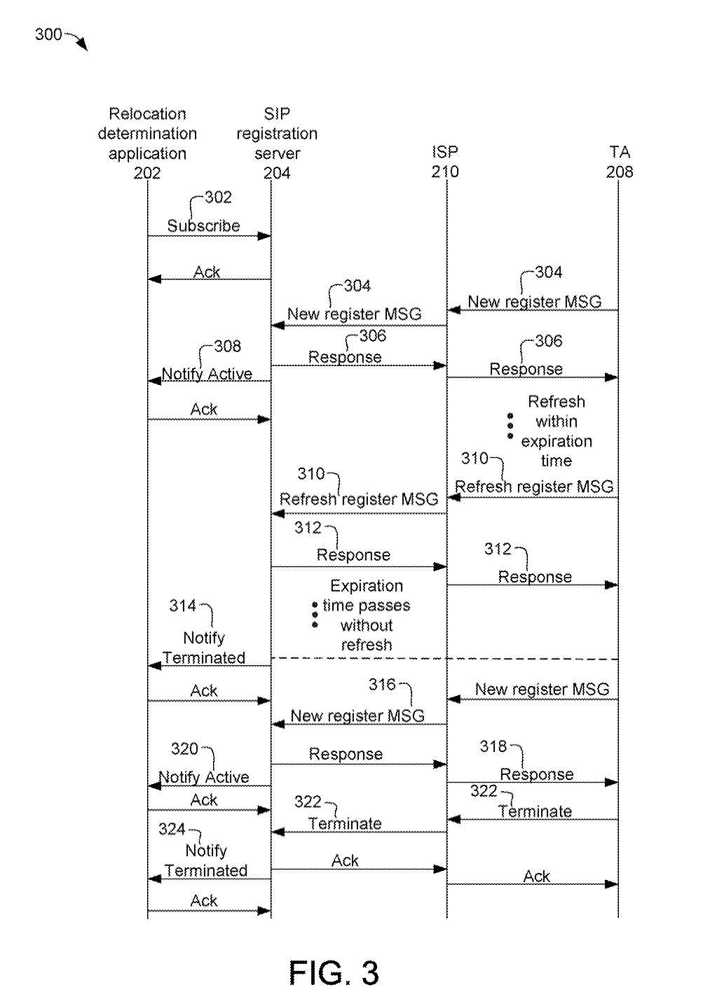

The relocation determination application 202 can subscribe to the registration events package in order to receive information about the registration of the TA 208. The registration events package 206 monitors registration events, such as registrations by the TA 208, or expiration of registrations. Based on the registration events, a registration state of the TA 208 is determined. The SIP registration server 204 notifies the relocation determination application 202 of registration state, and the relocation determination application 202 can determine whether the user may have changed locations based on the registration state. FIG. 3 describes particular messaging scenarios that could occur in the system 200, which would result in changes to registration state.

FIG. 3 shows exemplary messaging between a relocation determination application 202, a SIP registration server 204, an ISP 210 and a terminal adapter (TA) 208. In the illustrated scenarios, messages sent to and from the ISP 210 are generally passed on by the ISP 210 to the intended recipient, with no, or insubstantial change. The messaging scenarios shown typically begin after an OSP delivers the terminal adapter 208 to the customer. The OSP then subscribes to the SIP registration server 204 to track registration state of the TA 208.

Accordingly, the relocation determination application 202 subscribes to the registration events package of the SIP registration server 204 with a subscribe request 302. The subscribe request 302 provides a universal resource identifier (URI) that identifies the TA 208 to be monitored, and the name of the registration events package, and may provide other information such as a subscription expiration time. The SIP registration server 204 receives the subscribe request 302 and acknowledges receipt. The SIP registration server 204 sets up the subscription by identifying who the subscriber is, the resource to be monitored (i.e., the TA 208), and the events package to be used (in this case, the registration events package).

Sometime after the subscription is installed, the TA 208 will register with the SIP registration server 204. To do this, the TA 208 sends a new register message 304 via the ISP 210 to the SIP registration server 204. The new register message 304 includes a “From” header that includes the TA's 208 URI. The SIP registration server 204 validates the new register message 304 and sends a response 306 to the TA 208. Among other information, the response 306 includes a registration expiration time, which indicates the time by which the TA 208 is to refresh the registration.

The SIP registration server 204 determines that the URI matches the URI specified in the subscription request 302, and notifies the relocation determination application 202 with a notify message 308. The notify message 308 notifies the relocation determination application 202 that the TA 208 is in an active registration state. The relocation determination application 202 may then notify a billing process at the OSP that the customer has connected the TA 208, so that the billing process can begin billing the customer. The relocation determination application 202 acknowledges receipt of the notify message 308. The relocation determination application 202 may trigger a process of determining the geographic location (e.g., street address, latitude/longitude) of the TA 208.

Later, within the registration expiration time period previously provided in the response 306, the TA 208 sends a refresh register message 310. The SIP registration server 204 receives and validates the refresh register message 310, and sends another response 312. The response 312 includes another registration expiration time value, indicating the time in which the TA 208 is to refresh the registration.

In the illustrated scenario, the expiration time lapses without a refresh registration from the TA 208 being sent. After the expiration time passes, the SIP registration server 204 sends a notify message 314 to the relocation determination application 202. The notify message 314 notifies the relocation determination application 202 that the registration state for the TA 208 has entered a terminated state. The relocation determination application 202 acknowledges receipt of the notify message 314.

Sometime later, the TA 208 sends a new register message 316 to the SIP registration server 204 to newly register the TA 208 because its previous registration expired. The SIP registration server 204 responds to the TA 208 with a response 318 that includes another expiration time by which the TA 208 should respond to maintain the registration. The SIP registration server 204 sends a notify message 320 to the relocation determination application 202 to indicate that the TA 208 has an active registration state.

The transition from the terminated state to the active state indicates a potential change in location. As such, the relocation determination application 202 determines, based on the change in registration state, that the TA 208 and its user might have relocated. A process for determining the potentially new location of the TA 208 may then be triggered. The relocation determination application 202 acknowledges receipt of the notify message 320.

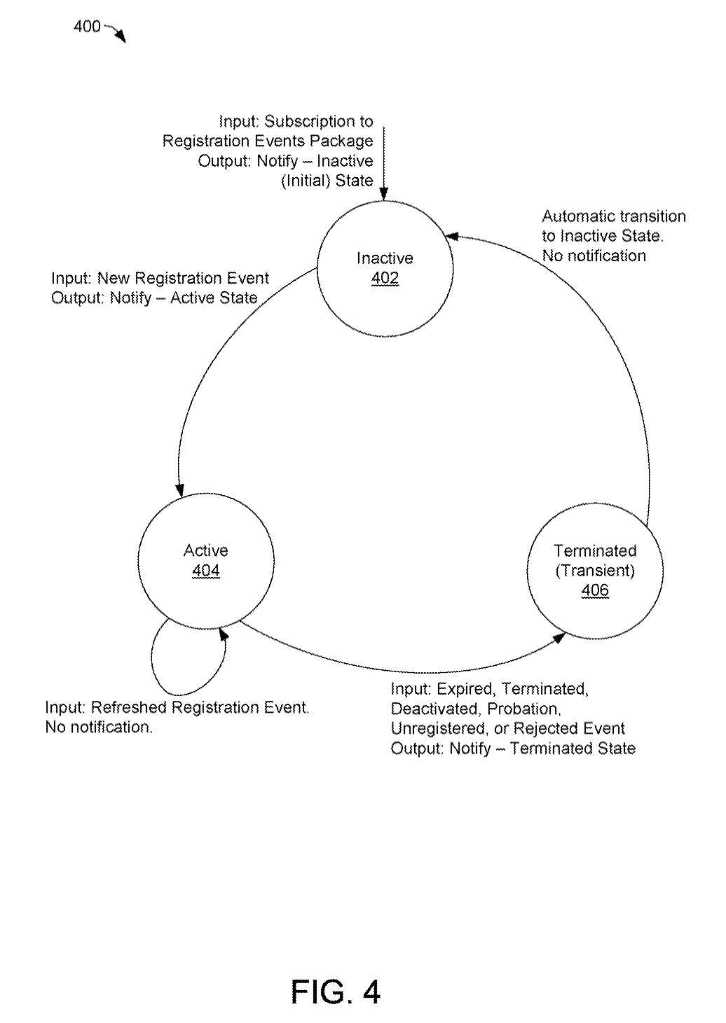

Later in the illustrated scenario, the TA 208 sends a terminate message 322. The terminate message 322 notifies the SIP registration server 204 that the TA 208 is actively terminating the registration. The SIP registration server 204 acknowledges receipt of the terminate message 322, and removes the registration of the TA 208 from the registry. The SIP registration server 204 then sends a notify message 324 to the relocation determination application 202. The notify message 324 notifies the relocation determination application 202 that the registration state has changed to the terminated state. FIG. 4 presents various exemplary registration states and is discussed in greater detail below.

FIG. 4 illustrates a finite state machine (FSM) 400 that can be implemented by a SIP registration server such as that shown in FIG. 3. The FSM includes three states: an inactive state 402, an active state 404, and a terminated state 406. The registrations server maintains a FSM 400 for each VoIP device user. The registrations server transitions from state to state depending on messages received from the VoIP device user. When the registrations events server transitions from one state to another, the registration server may notify a registrations events package subscriber of the state transition. The subscriber can use the registration state notifications to determine if the VoIP user might have relocated.

In this embodiment, when the registrations events package subscriber, such as an OSP, initially subscribes to the registrations events package, the state machine is in the inactive state 402. The inactive (or initial) state 402 is a state in which the VoIP device user is not registered with the network.

The registration server receives the registration message. This is a new registration event, and causes the registration events package to enter the active state 404. Upon entry into the active state 404, the registration server notifies the subscriber that the active state 404 is entered. In the active state 404, the VoIP device user can receive calls from the network. While in the active state 404, the VoIP device typically sends refresh registration messages before expiration times indicated in registration response messages issued by the registration server. As such, as long as the VoIP device sends refresh registration messages within the indicated expiration time period, the FSM 400 remains in the active state 404. The registration server does not notify the subscriber of a refresh registration because the FSM 400 remains in the active state 404.

Upon the occurrence of any of a number of deactivation events, the FSM 400 enters the terminated state 406. In this particular embodiment, events that cause the FSM 400 to enter the terminated state 406 are an expiration event, a terminated event, a deactivated event, a probation event, an unregistered event, or a rejected event. When one of these events occurs, the registration events package transitions from the active state 404 to the terminated state 406 and notifies the subscriber of entry into the terminated state 406. The terminated state 406 is a transient state, meaning that the registration events package does not remain in the terminated state 406. Rather, the FSM 400 transitions immediately back into the inactive state 402. The subscriber is not notified of entry into the inactive state. In some embodiments, the FSM 400 is deleted from server memory upon re-entry into the inactive state 402, though the subscription remains in memory until some subscription event removes it.

### Exemplary Operations

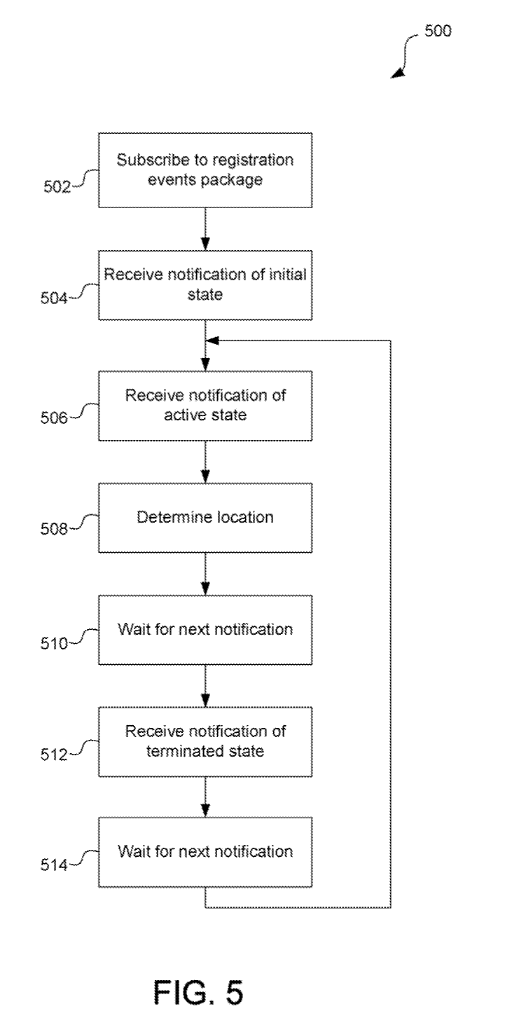

FIG. 5 illustrates an algorithm 500 that can be carried out by an application server of an online service provider (OSP) such as that shown in FIG. 2 to determine whether a VoIP device user might have moved locations, using notifications of registration state indicated in the FSM 400 of FIG. 4.

The subscriber (e.g., an OSP) subscribes to the registration events package in a subscribing operation 502. One embodiment of the subscribing operation involves the application server of the OSP sending a subscribe message to the registration server of a VoIP wholesale network provider. The subscribe message includes header values that identify the registration events package being subscribed to, as well as the user and/or the VoIP device that is to be monitored. For example, the subscribe message can include an Event header that indicates the type of state for which a subscription is being requested, which, in this case will correspond to the registration events package. The user and/or the user's device may be identified with a Universal Resource Identifier (URI). The subscribe message may include other information such as an expiration time value, an accepted notification format, or others.

In a receiving operation 504, the application server is notified of the current registration state. In this scenario, the current registration state is an inactive state in which the VoIP device is not recognized. The notify message that is received indicates the URI, the registration state, and the associated subscription. Another receiving operation 506 receives a notification of entry into the active registration state. The notify message in this case indicates the active state. Because this is the first time the user has registered, the user relocation determination application may attempt to determine the current location of the user.

The application server determines the location of the user in a determining operation 508. One embodiment of the determining operation 508 triggers a call to the user and has the user input the current location using an interactive voice response (IVR) system. The IVR system may accept keypad alphanumeric entry and/or voice with voice recognition. Other ways of determining location may be employed. By way of example, but not limitation, the user's VoIP device may be Global Positioning System (GPS)-enabled, and be capable of automatically relaying its position. In such a case, the determining operation 508 may prompt the VoIP device for the GPS location.

The application server then waits for the next notification in a waiting operation 510. As discussed above, the registration state will typically stay in the active state until some sort of deactivation event occurs. To illustrate, in actual operation another receiving operation 512 receives a notification that the registration state is the terminated state. The application server then waits in a waiting operation 514 for the next notification. Typically, the next notify message will indicate that the active state has been re-entered in the receiving operation 506. The transition from the terminated state to the active state is an indication that the user has potentially moved locations. As such, the determining operation 508 will again attempt to determine the location of the user because the user has potentially moved. The process continues in this fashion until the subscription expires.

### Exemplary Computing Device

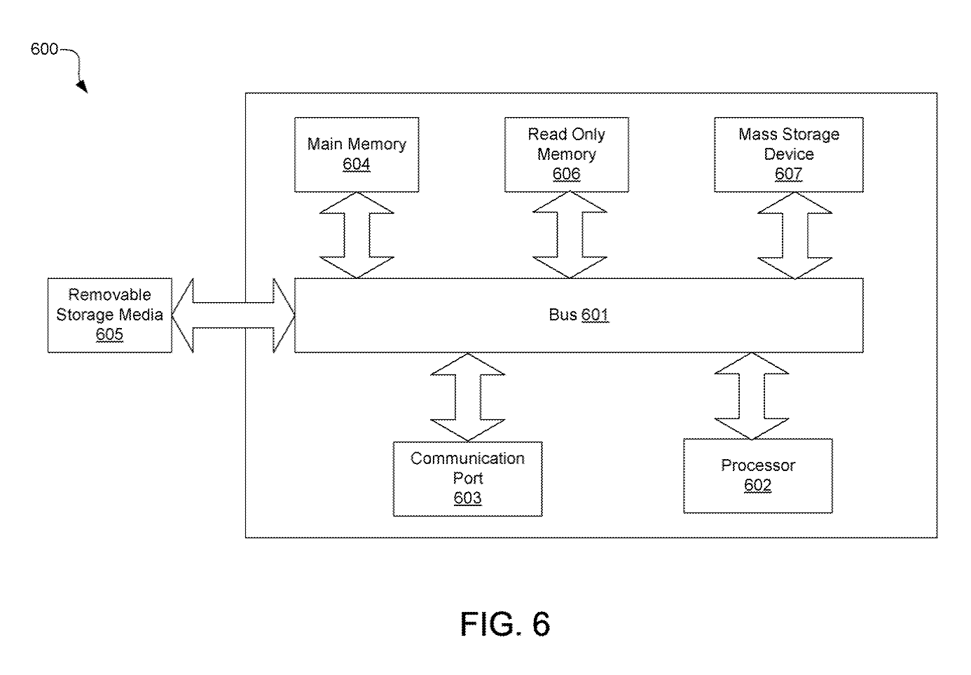

FIG. 6 is a schematic diagram of a computing device 600 upon which embodiments of the present invention may be implemented and carried out. The components of the computing device 600 are illustrative of components that a SIP registration server may include or a server computer that carries out a relocation determination process as discussed above.

As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 600 includes a bus 601, at least one processor 602, at least one communication port 603, a main memory 604, a removable storage media 605 a read only memory 606, and a mass storage 607. Processor(s) 602 can be any know processor, such as, but not limited to, an Intel® Itanium® or Itanium 2® processor(s), or AMD® Opteron® or Athlon MP® processor(s), or Motorola® lines of processors. Communication port(s) 603 can be any of an RS-232 port for use with a modem based dialup connection, a 10/100 Ethernet port, a Gigabit port using copper or fiber, or a USB port. Communication port(s) 603 may be chosen depending on a network such a Local Area Network (LAN), Wide Area Network (WAN), or any network to which the computing device 600 connects. The computing device 600 may be in communication with peripheral devices (not shown) such as, but not limited to, printers, speakers, cameras, microphones, or scanners.

Main memory 604 can be Random Access Memory (RAM), or any other dynamic storage device(s) commonly known in the art. Read only memory 606 can be any static storage device(s) such as Programmable Read Only Memory (PROM) chips for storing static information such as instructions for processor 602. Mass storage 607 can be used to store information and instructions. For example, hard disks such as the Adaptec® family of SCSI drives, an optical disc, an array of disks such as RAID, such as the Adaptec family of RAID drives, or any other mass storage devices may be used.

Bus 601 communicatively couples processor(s) 602 with the other memory, storage and communication blocks. Bus 601 can be a PCI/PCI-X, SCSI, or USB based system bus (or other) depending on the storage devices used. Removable storage media 605 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, white the embodiments described above refer to particular features, the scope of this invention also includes embodiments having different combinations of features and embodiments that do not include alt of the described features. Accordingly, the scope of the present invention is intended to embrace alt such alternatives, modifications, and variations together with all equivalents thereof.

What is claimed is:

1. A method for determining potential relocation of an Internet Protocol (IP)-enabled telephony device, the method comprising:
subscribing to a registration events package of a Voice over IP (VoIP) network to which at least the IP-enabled telephony device is communicably connected;
receiving one or more notifications indicating a registration state of the IP-enabled telephony device; and
based on one or more registration state changes, determining that the IP-enabled telephony device has potentially relocated.

2. The method as recited in claim 1, further comprising determining the location of the IP-enabled device only if the registration state indicates that the device has potentially relocated.

3. The method as recited in claim 1, wherein the receiving operation comprises:
receiving a notify message indicating that the IP-enabled telephony device is in an active registration state.

4. The method as recited in claim 3, wherein the receiving operation further comprises:
receiving a notify message indicating that the IP-enabled telephony device is in a terminated registration state; and
receiving another notify message indicating that the IP-enabled telephony device is in the active registration state.

5. The method as recited in claim 4, wherein the determining operation comprises determining that a transition from the terminated registration state to the active registration state indicates that the IP-enabled telephony device has potentially relocated.

6. The method as recited in claim 1, further comprising:
receiving a notify message indicating that the IP-enabled telephony device has entered an active registration state; and
determining that a billing process should begin based on the IP-enabled telephony device's entry into the active registration state for an initial time.

7. The method as recited in claim 1, further comprising initiating a process to determine the location of the IP-enabled telephony device based on an indication that the IP-enabled telephony device has potentially relocated.

8. A system for determining potential relocation of a user of a Voice over Internet Protocol (VoIP)-enabled device, the system comprising:
an application server comprising a user relocation determination application operable to subscribe to a VoIP registration events package and determine whether the user has potentially relocated based on a change in registration state of the user's VoIP-enabled device.

9. The system as recited in claim 8 wherein the application server is further operable to determine that the VoIP-enabled device has potentially relocated based on a change in registration state from a terminated registration state to an active registration state.

10. The system as recited in claim 8 wherein the application server is further operable to initiate a billing process based on a notification that the VoIP-enabled device has entered an active registration state for an initial time.

11. The system as recited in claim 8 wherein the application server is further operable to initiate a location determination process that determines a new location of the VoIP-enabled device.

12. A computer-readable medium having computer-executable instructions, which, when executed, cause a computer to implement a process, the process comprising:
subscribing to a registrar of a VoIP network associated with a customer VoIP-enabled device before said device has been activated for an initial time;
receiving a first message from the registrar indicating that the customer VoIP-enabled device has entered an active state;
based on the first message indicating that the VoIP-enabled device has entered the active state, beginning a billing process to bill the customer for use of the VoIP-enabled device;
receiving one or more other messages from the registrar indicating that the VoIP-enabled device has re-entered the active state from a terminated state; and
based on the message indicating that the VoIP-enabled device has re-entered the active state from the terminated state, determining that the VoIP-enabled device has potentially relocated.

13. The computer-readable medium as recited in claim 12, the process further comprising, initiating a process for determining a potentially new location of the VoIP-enabled device based on the determination that the VoIP-enabled device has potentially relocated.

14. The computer-readable medium as recited in claim 12, the process further comprising, automatically notifying an Enhanced 911 service of the determined new location.

15. The computer-readable medium as recited in claim 12, wherein receiving one or more other messages comprises:
receiving a message indicating that the VoIP-enabled device has entered the terminated state;
waiting for a message indicating that the VoIP-enabled device has re-entered the active state; and
receiving the message indicating that the VoIP-enabled device has re-entered the active state.
